(19) United States
(12) Patent Application Publication
(10) Pub. No.: US 2004/0133699 A1
(43) Pub. Date: Jul. 8, 2004

(54) System and method for performing data transfer

(76) Inventors: Tony Hashem, Lynchburg, VA (US); Keri A. Quinn, Branford, CT (US); Art Richards, Forest, VA (US)

Correspondence Address: HUNTON & WILLIAMS LLP, INTELLECTUAL PROPERTY DEPARTMENT, 1900 K STREET, N.W., SUITE 1200, WASHINGTON, DC, 20006-1109, US

(21) Appl. No.: 10/309,084

(22) Filed: Dec. 4, 2002

(51) Int. Cl. G06F 15/16

(52) U.S. Cl. 709/237; 709/206

(57) ABSTRACT

The invention provides a method and system for performing data transfer with a destination entity. The system may comprise a generation portion that performs a data set generation process to generate a data set, the data set to be forwarded to the destination entity; a tracking portion that inputs tracking data regarding operations performed on the data set; and a transmission portion, the transmission portion receiving the data set from the generation portion and transmitting the data set to the destination entity, the transmission portion outputting transmission notification information to the tracking portion in conjunction with transmitting the data set to the destination entity. Further, the system may include a communication portion for receiving an acknowledgement from the destination entity, the communication portion outputting any received acknowledgment to the tracking portion. The tracking portion generates a report including information relating to the transmission notification information and the acknowledgment to provide confirmation of receipt, by the destination entity, of the data set.

### BACKGROUND OF THE INVENTION

The invention relates generally to systems and methods for performing data transfer, and more particularly, to the tracking of data sets between respective entities.

As companies and other entities become more technologically advanced, and with the ever increasing acceptance of the Internet, there is an increasing demand to provide more effective and efficient communications between entities. For example, a particular company may work with hundreds or thousands of customers on a daily basis.

It is typical that substantial amounts of information, including files or other data, are passed between a company and its various customers, for example. Further, it is often times very important that this communicated information be successfully exchanged between entities. As should be appreciated, the occurrence of lost files or other lost information is often times simply not acceptable in today's competitive environment. Further, the known techniques for performing data transfer simply do not address the needs of current business practices.

The invention provides systems and methods, for performing data transfer, that offer features not present in known techniques.

### BRIEF SUMMARY OF THE INVENTION

The invention provides systems and methods for performing data transfer. In accordance with one embodiment of the invention, the system includes a generation portion that performs a data set generation process to generate a data set, the data set to be forwarded to the destination entity; a tracking portion that inputs tracking data regarding operations performed on the data set; and a transmission portion, the transmission portion receiving the data set from the generation portion and transmitting the data set to the destination entity, the transmission portion outputting transmission notification information to the tracking portion in conjunction with transmitting the data set to the destination entity. Further, the system may include a communication portion for receiving an acknowledgement from the destination entity, the communication portion outputting any received acknowledgment to the tracking portion. The tracking portion generates a report including information relating to the transmission notification information and the acknowledgment to provide confirmation of receipt, by the destination entity, of the data set.

In accordance with a further embodiment, the invention provides a system comprising a generation portion that performs a data set generation process to generate a data set, the data set to be forwarded to the destination entity; a tracking portion that inputs tracking data regarding operations performed on the data set, the generation portion outputting generation notification information to the tracking portion in conjunction with performing the data set generation process; a transmission portion, the transmission portion receiving the data set from the generation portion and transmitting the data set to the destination entity, the transmission portion outputting transmission notification information to the tracking portion in conjunction with transmitting the data set to the destination entity; an encryption portion that performs an encryption process on the data set, the transmission portion receiving the data set from the generation portion through the encryption portion, and the encryption portion outputting encryption notification information to the tracking portion in conjunction with performing the encryption process; and a communication portion for receiving an acknowledgement from the destination entity, the communication portion outputting any received acknowledgment to the tracking portion. The tracking portion generates a report including information relating to the generation notification information, the transmission notification information, the encryption notification information and the acknowledgment to provide confirmation of receipt, by the destination entity, of the data set.

In accordance with a further embodiment, the invention provides a method comprising performing a data set generation process in a generation portion to generate a data set, the data set to be forwarded to the destination entity; outputting the data set from the generation portion to a transmission portion, the transmission portion receiving the data set from the generation portion; transmitting the data set from the transmission portion to the destination entity, the transmission portion outputting transmission notification information to a tracking portion in conjunction with transmitting the data set to the destination entity; inputting an acknowledgement, by the tracking portion, from the destination entity; and generating a report, by the tracking portion, the report including information relating to the transmission notification information and the acknowledgment to provide confirmation of receipt, by the destination entity, of the data set.

In accordance with a further embodiment, the invention provides a method comprising performing a data set generation process in a generation portion to generate a data set, the data set to be forwarded to the destination entity, the generation portion outputting generation notification information to a tracking portion in conjunction with performing the data set generation process; outputting the data set from the generation portion to a transmission portion, the transmission portion receiving the data set from the generation portion; performing an encryption process on the data set by an encryption portion, the transmission portion receiving the data set from the generation portion through the encryption portion, the encryption portion outputting encryption notification information to the tracking portion in conjunction with performing the encryption process; transmitting the data set from the transmission portion to the destination entity, the transmission portion outputting transmission notification information to the tracking portion in conjunction with transmitting the data set to the destination entity; inputting an acknowledgement, by the tracking portion, from the destination entity, wherein the inputting includes the acknowledgment being input through a communication portion, the communication portion being an e-mail server; and generating a report, by the tracking portion, the report including information relating to the generation notification information, the encryption notification information, the transmission notification information and the acknowledgment, to provide confirmation of receipt, by the destination entity, of the data set; and wherein the tracking portion includes a log file portion, the log file portion including log files for a plurality of destination entities. Each log file for a respective customer includes a processing log file record, which is generated based on processing of the data set prior to transmitting the data set and including the transmission notification information, the generation notification information and the encryption notification information, and an acknowledgment log file record, which is generated based on the acknowledgment. The method further includes comparing data in the processing log file record with data in the acknowledgment log file record to determine receipt of data sets by the destination entity; and outputting comparison data to a results log file record in a log file for a respective customer, the comparison data showing acknowledgment of files and non-acknowledgment of files.

### BRIEF DESCRIPTION OF THE DRAWINGS

The present invention can be more fully understood by reading the following detailed description together with the accompanying drawings, in which like reference indicators are used to designate like elements, and in which: embodiment of the invention;

FIG. 2 is a flowchart showing a tracking process in accordance with one embodiment of the invention;

FIG. 3 is a flowchart showing the “initial file processing and transmission of file” step of FIG. 2 in further detail in accordance with one embodiment of the invention;

FIG. 4 is a flowchart showing the run check of “processing log file record” versus “acknowledgement log file record” step of FIG. 2 in further detail in accordance with one embodiment of the invention;

FIG. 5 is a flowchart showing the “review status of each customer” step of FIG. 4 in further detail in accordance with one embodiment of the invention;

FIG. 6 is a block diagram showing the “tracking portion” of FIG. 1 in further detail in accordance with one embodiment of the invention;

FIG. 7 is a screen shot showing aspects of downloaded reconciliation results in accordance with one embodiment of the invention; and

FIG. 8 is a screen shot showing further aspects of downloaded reconciliation results in accordance with one embodiment of the invention.

### DETAILED DESCRIPTION OF THE INVENTION

Hereinafter, various embodiments of the invention will be described. As used herein, any term in the singular may be interpreted to be in the plural, and alternatively, any term in the plural may be interpreted to be in the singular.

The systems and methods as disclosed herein are directed to the above stated problems, as well as other problems, that are present in conventional techniques. The foregoing description in the “Background of the Invention” is in no way intended to limit the scope of the invention, or to imply that the invention does not include some or all of various elements of known products, methods, and/or apparatus in one form or another. Indeed, various embodiments of the invention may be capable of overcoming some of the disadvantages noted in the “Background of the Invention,” while still retaining some or all of the various elements of known products, methods, and apparatus in one form or another.

The invention provides a combination of technology to allow a user or company, for example, to transmit files to and from multiple sources or destinations via the Internet or other network system in a secure manner. The invention further provides a system for guarantee of delivery or alternatively, the detection of errors or failure in an attempted delivery. Further, the invention provides the transactional logging of events. The process may be implemented by an individual or company, for example, to send a wide variety of information to a destination entity, such as a customer or business, for example.

In one implementation of the system, the process begins when a data file is generated within an entity, such as a company, for example. In accordance with one embodiment of the invention, the company maintains what may be called a company system. The file needs to be sent to a destination outside of the company. The file may be first passed to an encryption module, which encrypts the file based on the destination of the file. The file is then passed to a transmission portion. The transmission portion then transmits the file to the destination site, such as a customer. When the file is received at the destination, the receiving system is expected to send a notification back to the company system.

In accordance with one embodiment of the invention, at each step of the process, log files are generated. These log files may be stored on what might be characterized as a tracking portion or database. The tracking database, which is supported by suitable software, stores various events related to the transmittal of the file between the company system and the customer, or alternatively, some other destination.

In one aspect of the operation of the tracking database, the tracking database expects to receive the acknowledgement from the destination system when the file is successfully received by the destination system. If the tracking database does not get a response, the tracking database interprets this to mean that the destination system, i.e., the customer for example, did not send an acknowledgement of receipt. As a result, the tracking database will generate an “error code.” The error might occur because the file was not successfully received by the customer, or alternatively, because the customer did indeed receive the file, but simply did not provide a response to the company system.

In turn, the error code causes the tracking database to create and send an e-mail to an appropriate person or system, for example. The e-mail might be sent to technical support, or alternatively, the e-mail might page a technician. In short, however, every file sent to the destination system is accounted for, thereby assuring delivery of data, or alternatively, notification that the data was not delivered.

The systems and methods of the invention provide an approach to monitoring the processing of files, both in a company system and by a customer, in an economical and effective manner, as is described in detail below. The invention provides a fully rectifiable and secure transmission sending and receiving system that may operate over the Internet, for example, in accordance with one embodiment of the invention. Accordingly, the Internet usage may be virtually free, in sharp contrast to the “per usage” fees often encountered in secure transmissions. Further, the systems and methods of the invention avoid the need for a dedicated connection between entities that are exchanging files of data.

Hereinafter, further aspects of the invention will be described with reference to FIG. 1. FIG. 1 is a block diagram showing a data transfer system 100 in accordance with one embodiment of the invention. As shown, the data transfer system 100 includes a company system 102 and a customer 180. The data transfer system 100 in accordance with one embodiment of the invention, may be used and maintained by a particular entity or company. For purposes of illustration, such a company will herein be described as “Company-A.” Further, the data transfer system 100 might be implemented by Company-A to deliver life insurance pending case statuses, agent commission data and/or licensing information, for example. This information is of course very important for customers of Company-A, i.e., important so that the customers of Company-A may run their business. Company-A maintains the company system 102.

It should be appreciated that the nature of information processed by the data transfer system 100 may typically be highly sensitive. Further, even one file missing can and will have an impact on the customer. For example, if a pending case status is missing, the customer will not be aware of a case status change, unless by some chance the customer contacts Company-A. This leads to delays in the processing of any of a variety of transactions, such as life insurance applications, for example. Such delays and other deficiencies may cause the customer to go to another carrier, i.e., other than Company-A. This is of greater concern since the files may well contain personal, medical and financial information, even though the files are typically encrypted.

As shown in FIG. 1, the company system 102 includes a central system 110, i.e., a data set “generation portion.”. The central system 110 generates new files as is described below. The central system 110 may be in the form of a mainframe system, for example. The central system 110 may communicate with any of a wide variety of systems and/or databases (not shown) to generate the new files. These systems with which the central system 110 interact may be either internal or external to the company system 102.

The company system 102, in accordance with one embodiment of the invention, further includes an encryption portion 120, a transmission portion 130 and a mail server 140. The mail server receives data from the customer 180, as described below. The company system 102 also includes a tracking portion 150. The tracking portion 150 receives a variety of information from the various components in the company system 102, as well as from the customer 180. It should of course be appreciated that the customer 180 is illustrative, and that any number of other customers may interact with the company system 102 in the same manner as customer 180.

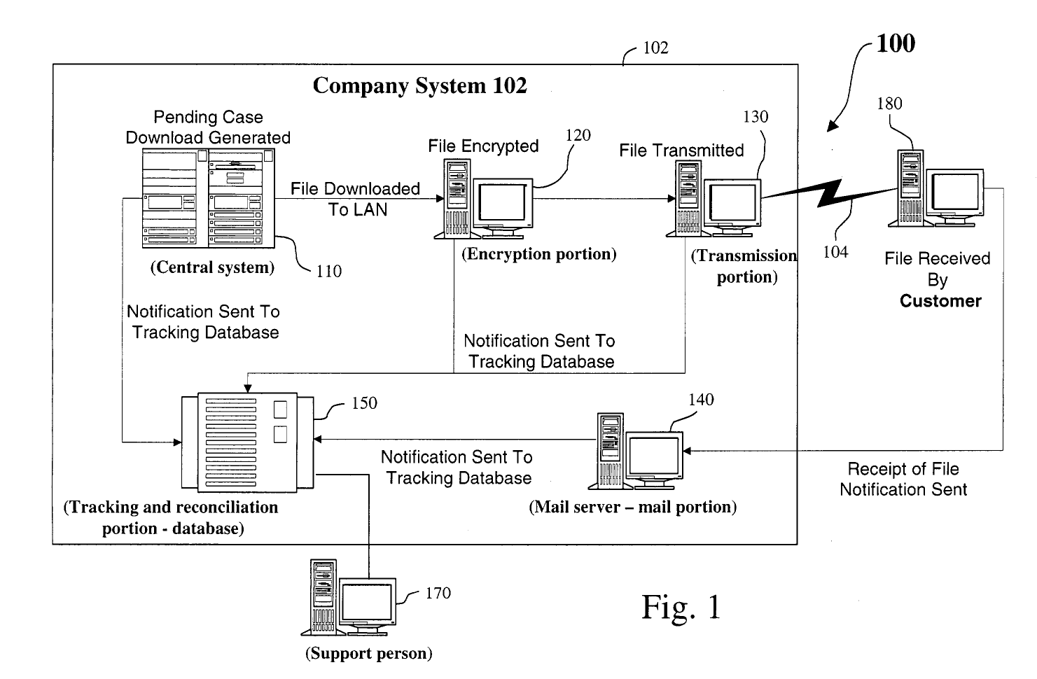

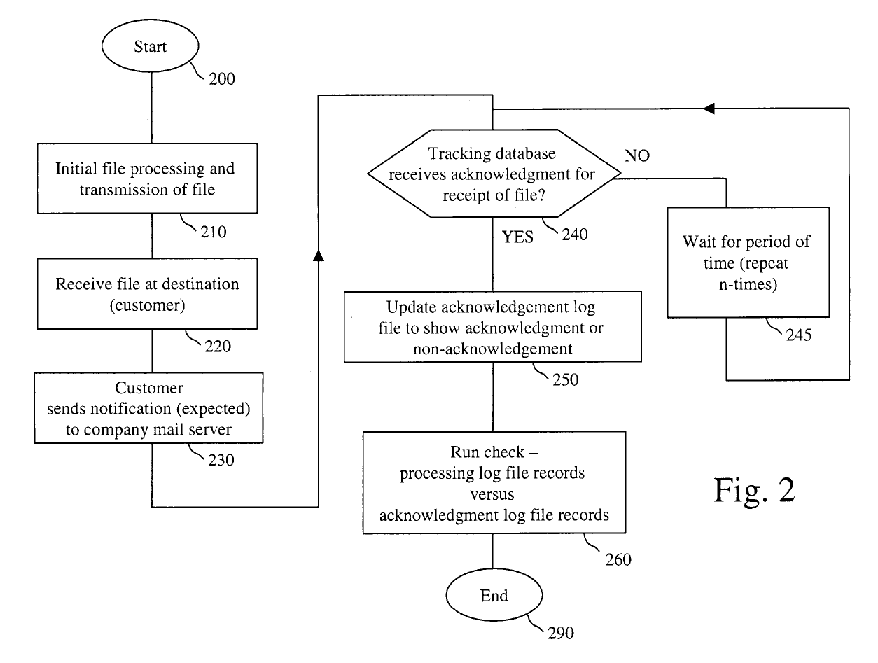

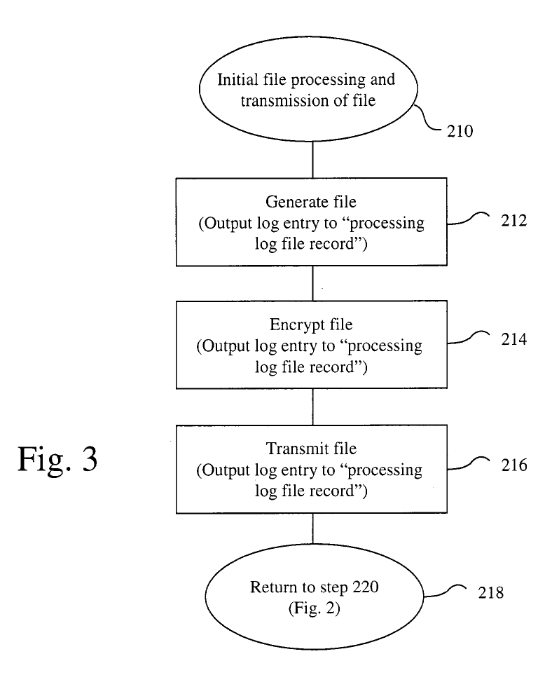

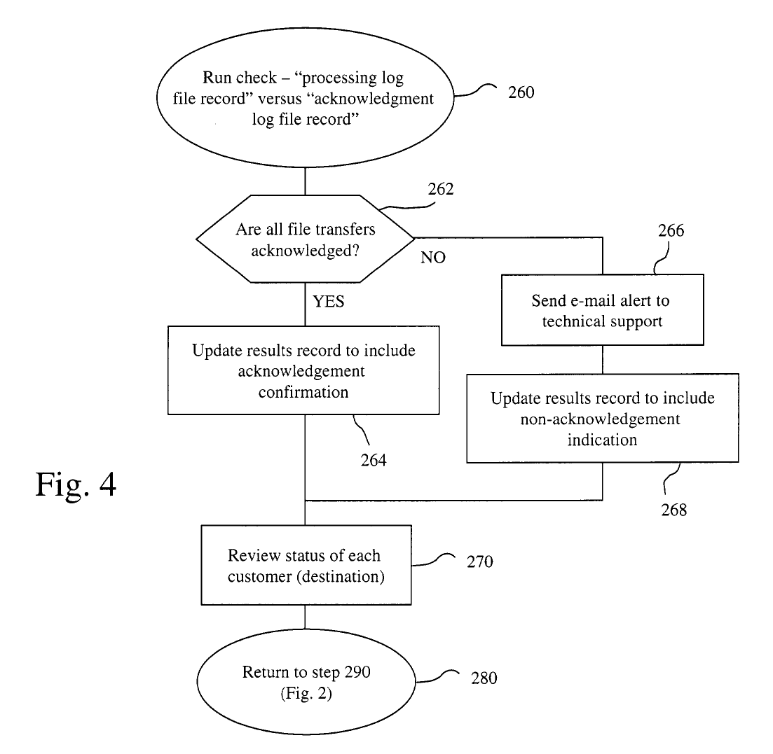

In accordance with one embodiment of the invention, FIG. 2 is a high level flowchart showing a data transfer process. The process of FIG. 2, as described below, is performed by the data transfer system 100. However, other suitable systems may alternatively be implemented to practice the process of FIG. 2.

As shown in FIG. 2, the process starts in step 200. That is, in accordance with one embodiment of the invention, the process starts when a file, i.e., any of the above described files, is created and is to be sent to a particular destination. After step 200, the process passes to step 210. In step 210, the initial file processing is performed. Once this initial processing of the file is performed, the file is then transmitted by the central system 110 to customer 180.

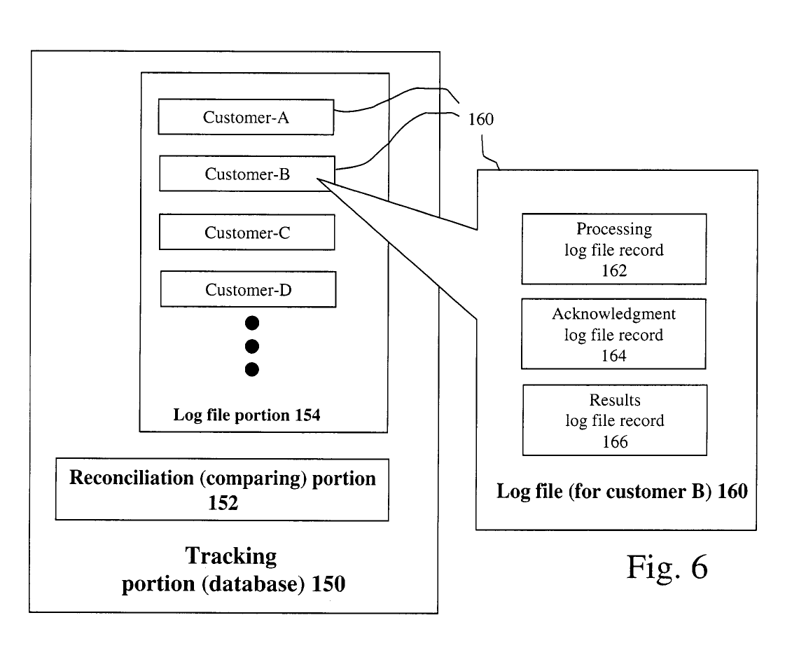

To explain further, FIG. 3 is a flowchart showing in further detail the “initial file processing and transmission of file” step 210 of FIG. 2. As shown in FIG. 3, after step 210, the process passes to step 212. In step 212, the central system 110 generates the file and outputs the file to the encryption portion 120. Each file generated will have a unique file name as to prevent one file overwriting another. Concurrently with generation of the file, the central system 110 outputs a notification to the tracking portion 150 regarding the events surrounding the file generation. Specifically, the central system 110 outputs a log entry to a processing log file record 162, as shown in FIG. 6 and discussed in detail below. The log entry may be transmitted to the tracking portion 150 in any suitable manner. For example, the log entry may be transmitted from the central system 110 to the tracking portion 150 using e-mail over a network. In a similar manner, log entries may be transmitted from the encryption portion 120 and/or the transmission portion 130 to the tracking portion 150, as described below.

After step 212 of FIG. 3, the process passes to step 214, as shown in FIG. 3. In step 214, the encryption portion 120 inputs the file from the central system 110. This inputting may involve the file being downloaded to a holding area for processing, and then passed on to the encryption portion 120.

In accordance with one embodiment of the invention, the file is placed into an appropriate directory in the encryption portion 120. The directory is significant since it is the directory that determines the destination of the file. That is, the encryption portion 120, based on the directory in which the file is located, encrypts the file with the correct encryption for the destination, in accordance with one embodiment of the invention. For example, the encryption portion 120 might use a “public key” encryption.

To explain further, in accordance with one embodiment of the invention, the encryption portion 120 has directories set up for each destination that the file may be transmitted to. Each of these directories in the encryption portion 120 possesses its own individual public key for encryption. Correspondingly, only the destination, such as a particular customer, for example, has the private key to decrypt the file. Step 214 also includes the encryption portion 120 outputting a log entry to the processing log file record 162. The log entry includes a portion of the events or all the events surrounding the processing in the encryption portion 120, as desired. Verification of the encryption is then performed. However, it should also be appreciated that a variety of encryption products or methods may also be used in conjunction with the processing of the encryption portion 120. Further, a variety of “off-the-shelf” software might be used to provide encryption capabilities, depending on the requirements of the particular customer, for example.

Once verification of encryption has completed, the process of FIG. 3 passes from step 214 to step 216. In step 216, the file is transmitted to the proper destination directory in the transmission portion 130. In accordance with one embodiment of the invention, each potential destination, and the information to connect to that destination, is linked to the destination directory structure of the transmission portion 130. Alternatively, the transmission portion 130 might determine the destination of the file in some other manner, such as by reading a particular field of data in the file, for example. Once the transmission portion 130 receives the file in step 216, the transmission portion 130 connects to the destination's site, such as an FTP (File Transfer Protocol) site for example, and transmits the file. The transmission portion 130 will try repeatedly to transmit the file until the transmission portion 130 reaches the end of its retries, or alternatively, the file successfully transmits. The transmission portion 130 might use various forms of known communications to transmit or send the file to the destination, such as e-mail or other messaging systems or techniques, for example.

Based on the operations of the transmission portion 130 in processing a file, the transmission portion 130 outputs a log entry to the tracking portion 150 regarding the events surrounding processing of the file in the transmission portion 130, and specifically to the processing log file record 162 in the tracking portion 150, in accordance with one embodiment of the invention. For example, if the file fails to transmit successfully, the tracking portion 150 is updated and an alert sent to a designated support person, for example. Alternatively, if the transmit is successful, the transmission portion 130 updates the tracking portion 150 to reflect the successful transmission. Further, the tracking portion 150 sets up an alert trigger, i.e., an alert to watch for an acknowledgement file to arrive from the destination. The acknowledgement signals that the destination has successfully received the file.

As described above, the encryption portion 120 encrypts the file in a suitable manner. As a result, if the file is inadvertently transmitted to the wrong destination, the data is still secure since the file is encrypted. That is, for example, the file may only be opened by the destination holding the private keys and password.

With further reference to FIG. 3, after step 216, the process passes to step 218. In step 218, the process returns to step 220 of FIG. 2.

As shown in FIG. 2, in step 220, the destination, i.e., a customer, for example, receives the file. Upon successful receipt of the file, in step 230, the destination is expected to send a specially formatted e-mail message to the mail server 140. For example, this might be a central support e-mail box on a Company-A mail server. This e-mail message may contain the file name, date and time received, as well as any other information, as is desired. For example, the e-mail message might contain suitable verification data so as to verify that the e-mail message was sent by the particular customer. The mail server may be an e-mail server or some other suitable communication portion.

Once the mail server 140, i.e., a communication portion, receives the e-mail message from the customer, the mail server 140 passes the message on to the tracking portion 150. Accordingly, in step 240 of FIG. 2, the tracking portion 150 checks to see if an acknowledgment has been received from the particular customer. The checking of step 240 may involve the e-mail message being held in some holding pool and being retrieved by the tracking portion 150, or alternatively, might involve the mail server 140 directly outputting the e-mail message to a suitable directory in the tracking portion 150. That is, the tracking portion 150 is updated to reflect that that a message, which was previously sent by the central system 110 via the encryption portion 120, was successfully received and acknowledged by the customer.

In further explanation of the present invention, FIG. 6 is a block diagram showing further details of the tracking portion 150, in accordance with one embodiment of the invention. As shown in FIG. 6, the tracking portion 150 includes a reconciliation portion 152 and a log file portion 154. The log file portion 154 may be in the form of a database. The log file portion 154 contains log files 160 for each customer of Company-A. Accordingly, it should be appreciated that the number of log files 160 may be in the thousands, for example. FIG. 6 illustrates further details of one exemplary log file, the log file 160 for customer “B.” It should be appreciated that the arrangement of the log file for customer B is typical of the arrangement of the other log files, in accordance with one embodiment of the invention.

The log file 160 for customer “B”, as shown in FIG. 6, includes a processing log file record 162, an acknowledgment log file record 164 and a results log file record 166. The processing log file record 162 is discussed above. That is, the company system 102 updates the processing log file record 162 subsequent to generation of the file by the central system 110, processing of a file by the encryption portion 120 and/or the transmission portion 130, for example.

Further, the acknowledgment log file record 164, as described below, is used by the tracking portion 150 to store information regarding acknowledgments from customers, or alternatively, lack of acknowledgment by a customer. Acknowledgement data, which is received from customers, is input by the mail server 140 and conveyed to the tracking portion 150 in a suitable manner, as described above.

The tracking portion 150 also contains a reconciliation portion 152. The reconciliation portion 152 is a processing portion in the tracking portion 150. The reconciliation portion 152 compares data in the processing log file record 162 against data in the acknowledgment log file record 164. Further, the reconciliation portion 152 stores the results of such comparison in the results log file record 166. Operation of the reconciliation portion 152, as well as generation of reports, for example, based on the “results log file record” 166, are described below.

In the above example, an e-mail message is sent from the customer 180 to the mail server 140, i.e., to provide notification of receipt of a particular file from the company system 102. However, it should of course be appreciated that forms of communication other than e-mail might be used, as desired. That is, other mail or messaging systems might be used, for example.

With further reference to FIG. 2, in step 240, the tracking portion or database 150 may determine that a message from the customer 180, acknowledging receipt of a file, has not been received by the company system 102. As a result, the process passes from step 240 to step 245. In step 245, in accordance with one embodiment of the invention, the tracking portion 150 waits for some predetermined period of time and then returns to step 240. Upon the return to step 240, the tracking portion 150 again checks for an acknowledgement from the customer 180, i.e., indicating that the customer 180 received the particular file. If the acknowledgment is still not received, the tracking portion 150 might again proceed to step 245 and wait. As illustrated in FIG. 2, the “wait” step 245 will be repeated “n” times, where “n” is some suitable integer, as desired. After “n” times, the process will pass from step 240 to step 250, even though no acknowledgement is received from the customer. Accordingly, the acknowledgment log file record 164 is updated to reflect the non-acknowledgment.

Alternatively, in step 240, the tracking portion 150 may determine that the acknowledgment from the customer was indeed received. As a result, the process passes directly from step 240 to step 250. In this situation, the acknowledgment log file record 164 is updated to show “acknowledgment” by the customer.

Each morning or at some other predefined interval during the day, as desired, the tracking database will run a checking procedure which compares the files sent to the acknowledgements received. If the process detects any file transfers that are flagged as “not acknowledged”, an e-mail alert will be sent to technical support.

After step 250, the process passes to step 260. In step 260, the tracking portion 150 runs a check for each customer, as desired. For example, the tracking portion 150 might run a check of only customers that were forwarded files on the previous day. That is, for a particular log file 160, the tracking portion 150 compares the processing log file record 162 in that log file 160 against the acknowledgment log file record 164. In accordance with one embodiment of the invention, the data transfer system runs the checking procedure each morning for the previous day's data. This time sequence may be beneficial in that the destination system, i.e., the customer, can take a number of hours to acknowledge a download. Further, it is typically not necessary to have same day error reporting. However as needed, the reporting, including the response time of the destination system, can be adjusted to any specified time period.

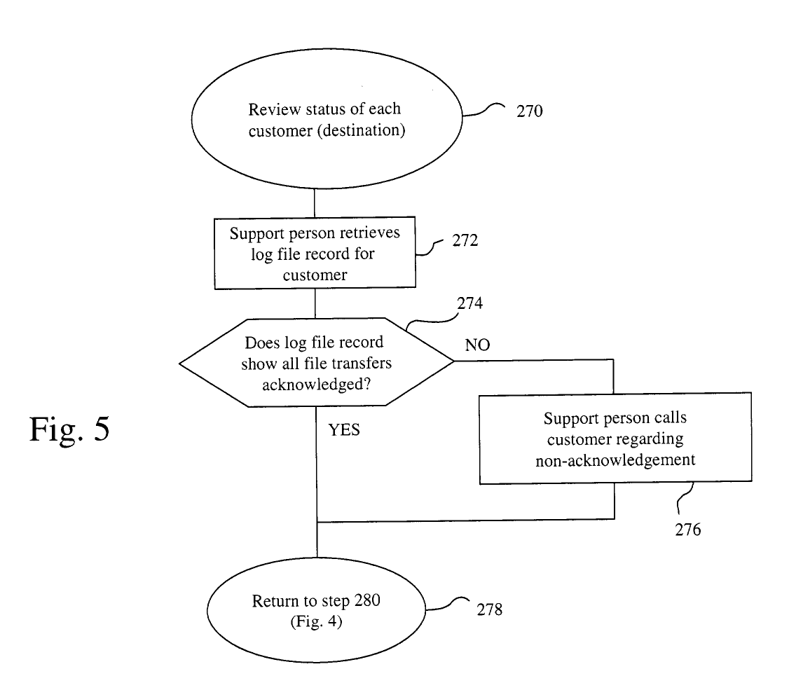

FIG. 4 is a flowchart showing in further detail step 260 of FIG. 2. As shown in FIG. 4, the sub-process starts in step 260 and passes to step 262. In step 262, the process queries whether all the file transfers have been acknowledged. If all the files have been acknowledged by the customers as being received, the process passes to step 264. In step 264, the tracking portion 150 updates the log file 160 to include acknowledgement confirmation, i.e., that all files have been acknowledged by the customer as received.

Alternatively, it may be the case that acknowledgement is not received for all the file transfers. For those files, the process passes from step 262 to step 266. In step 266, the process sends an e-mail alert to technical support identifying the file that was not acknowledgement, in accordance with one embodiment of the invention. For example, the technical support might simply be a support person 170, as shown in FIG. 1.

After step 266, the process passes to step 268. In step 268, the tracking portion 150 updates the results log file record 166 to include non-acknowledgement for the particular file. Accordingly, it should be appreciated that the log file 160 and specifically the results log file record 166, for a particular customer, may well contain confirmation of acknowledgement for many of the files that were sent from the company system 102 to a particular customer or customers 180, as well as indication that some files were not acknowledged by the customer 180.

After either step 264 or step 268, the process passes to step 270. In step 270, in accordance with one embodiment of the invention, the status of each customer or other destination is reviewed. This review might be done by a support person 170 or any other person or system, as desired. After step 270, the process passes to step 280. In step 280, the process returns to step 290 of FIG. 2. In step 290, as shown in FIG. 2, the process ends.

FIG. 5 is a flowchart showing in further detail the “review status of each customer” step 270 of FIG. 4. As shown in FIG. 5, the sub-process starts in step 270 and passes to step 272. In step 272, a support person retrieves the results log file record 166 from the customer's log file 160. After step 272, the process passes to step 274. In step 274, the support person, for example, reviews the log file record to determine whether all the file transfers for a particular customer have been acknowledged. If NO, then the process passes to step 276. In step 276, the support person contacts the customer regarding the non-acknowledgement of any files that have not been acknowledged by the customer, in accordance with one embodiment of the invention. However, it should be appreciated that the company system 102 may contact the customer 180 in any of a variety of manners to advise the customer of a non-acknowledgement of a file or files. As noted above, such non-acknowledgement might result from the customer not receiving the file, or alternatively, as a result of the file being received, but not acknowledged by the customer, for example. After step 276, the process passes to step 278.

Alternatively, the process may determine in step 274 that the log file does indeed show that all the files, which were sent to a particular customer, were indeed acknowledged by that customer. As a result, the process passes directly to step 278.

In step 278, the process returns to step 280 of FIG. 4. Thereafter, further processing is performed as described above.

As noted above, in step 272 of FIG. 5, the support person retrieves the “results log file record” 166. The results log file record 166 may be in the form of a report. In accordance with one embodiment of the invention, a separate report may be generated for each destination and then sent to a technical support person. The report may contain all the data processed the previous day, for example. Accordingly, the support person will see a list of all the successful and unsuccessful files and may contact the destination support personnel to verify if they received a particular file.

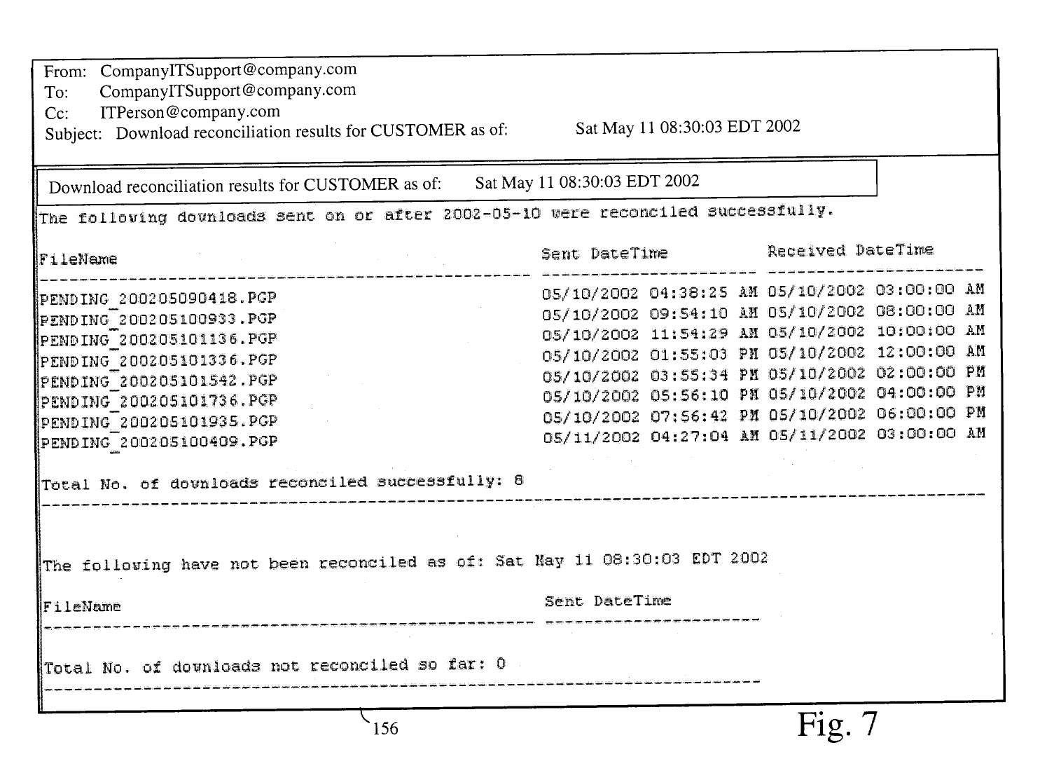

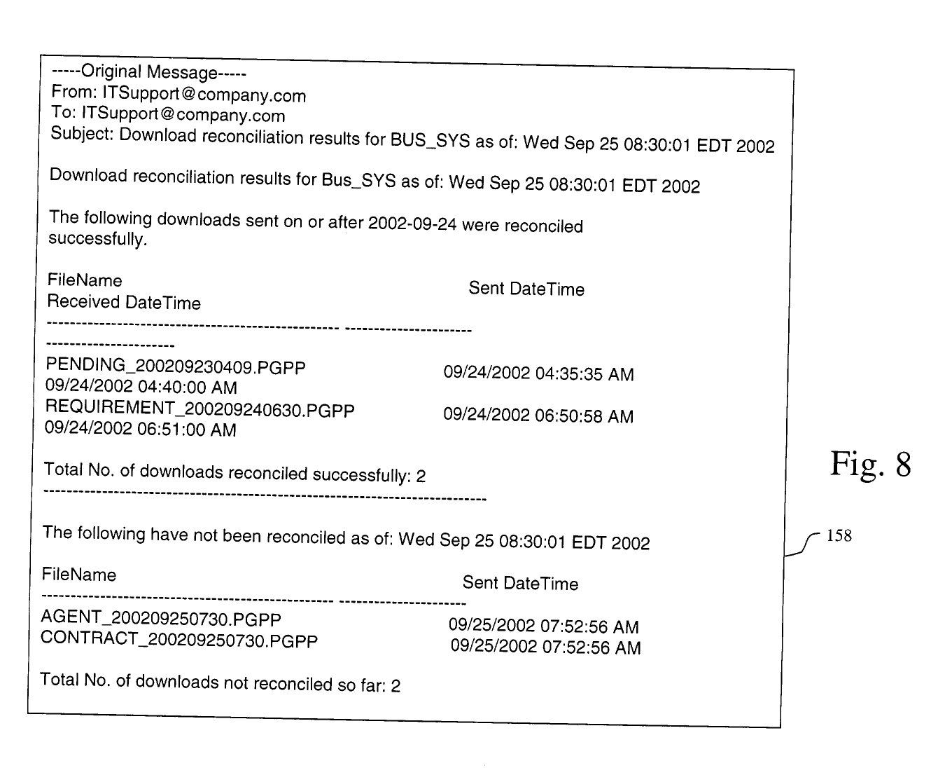

FIGS. 7 and 8 are illustrative screen shots showing examples of reports. The report 156 of FIG. 7 includes a listing of files that were sent to a customer of Company-A on a particular day. The report 156 includes information regarding when a file was sent, as well as when a particular file was received by the customer, i.e., indicating acknowledgement of receipt by the customer. As may be seen in FIG. 7, the report 156 also includes a section for files that have not been acknowledged by the customer, i.e., files that have not been reconciled. In the example of FIG. 7, all files have been acknowledged. It should be appreciated that a wide variety of reports may be created, as desired, based on the information in the tracking portion 150.

FIG. 8 is a further user interface 158 showing a report listing files that were sent to a customer of Company-A on a particular day. As shown in FIG. 8, two files were successfully received. However, two files, i.e., downloads, were not successfully received. The information provided by the report 158 allows a support person to contact the customer and effectively resolve the files that were not received by the customer.

As described above, transaction reporting is performed by the company system 102 at each step of the process and logged to the tracking portion 150. This reporting is used to ensure guarantee of data delivery, as shown by FIGS. 7 and 8. However, the reporting can be used for a variety of other purposes, such as used for performance metrics, for example. For example, it may be desired to gauge how long on average is taken for files to be transmitted to customers, to gauge customer acknowledgement time, or to analyze errors.

As described above, a file is generated in the central system 10, processed by the encryption portion 120 to encrypt the file as desired and passed onto the transmission portion 130 for transmission to a desired destination. Each of the portions (110, 120 and 130), as described above, outputs a log entry to the processing log file record 162. As used herein, a “log entry” means a data set, for example, that contains information regarding processing of a particular file or data set. As should be appreciated, the format and content of a log file may vary, as desired or as needed, based on the particular operating components. [0063] Accordingly, the processing log file record 162 may contain log file information from each of the central system 110, the encryption portion 120 and/or the transmission portion 130. The reconciliation portion 152 (in the tracking portion 150) may reconcile and/or compare any of the log file information from any of the components (110, 120 and 130). Further, the reconciliation portion 152 may reconcile and/or compare any of the log file information from any of the components (110, 120 and 130) with acknowledgement information received from a customer 180.

Accordingly, such information that is forwarded and stored in the log file 160 allows the reconciliation portion 152 to provide a variety of information to a support person, for example. Illustratively, process start time, process time and process end time may be compared for each of the central system 110, the encryption portion 120, the transmission portion 130, and/or other components that are used to process a file, i.e., prior to the file being forwarded to a customer. Accordingly, the reconciliation portion 152 may assist in identifying processing deficiencies in the company system 102, such as in a particular component.

Further, the reconciliation portion 152 may compare the processing in the components of the company system 102 with the acknowledgment, or non-acknowledgement, of a customer. This information might assist in trouble-shooting of the company system 102 and/or the customer's system. Illustratively, it might be determined that a processing lag in the encryption portion 120 corresponds to non-acknowledgement by a customer.

The systems and methods of the invention, in accordance with various embodiments, have been described above as generating and processing files and cases. However, it should be appreciated that the various systems and methods as described above may be used to process a wide variety of data or data sets, for example, in any of a wide variety of formats.

In further illustration of the invention, as described above, FIGS. 1 and 6 show one embodiment of the system of the invention. Further, FIGS. 2-5 show various steps of one embodiment of the method of the invention. The system of the invention or portions of the system of the invention may be in the form of a “processing machine,” such as a general purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above in the flowcharts. Such a set of instructions for performing a particular task may be characterized as a program, software program, or simply software.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general purpose computer. However, the processing machine described above may also utilize any of a wide variety of other technologies including a special purpose computer, a computer system including a microcomputer, mini-computer or mainframe for example, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the process of the invention.

It is appreciated that in order to practice the method of the invention as described above, it is not necessary that the processors and/or the memories of the processing machine be physically located in the same geographical place. That is, each of the processors and the memories used in the invention may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing as described above is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, or any client server system that provides communication, for example. Such communications technologies may use any suitable protocol such as TCP/IP, UDP, or OSI, for example.

As described above, a set of instructions is used in the processing of the invention. The set of instructions may be in the form of a program or software. The software may be in the form of system software or application software, for example. The software might also be in the form of a collection of separate programs, a program module within a larger program, or a portion of a program module, for example The software used might also include modular programming in the form of object oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instructions or single programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, communications channel, a satellite transmissions or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, voice reader, voice recognizer, dialogue screen, menu box, list, checkbox, toggle switch, a pushbutton or any other device that allows a user to receive information regarding the operation of the processing machine as it processes a set of instructions and/or provide the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A system for performing data transfer with a destination entity, the system comprising:
a generation portion that performs a data set generation process to generate a data set, the data set to be forwarded to the destination entity;
a tracking portion that inputs tracking data regarding operations performed on the data set;
a transmission portion, the transmission portion receiving the data set from the generation portion and transmitting the data set to the destination entity, the transmission portion outputting transmission notification information to the tracking portion in conjunction with transmitting the data set to the destination entity;
a communication portion for receiving an acknowledgement from the destination entity, the communication portion outputting any received acknowledgment to the tracking portion; and
wherein the tracking portion generates a report including information relating to the transmission notification information and the acknowledgment to provide confirmation of receipt, by the destination entity, of the data set.

2. The system of claim 1, wherein the generation portion outputs generation notification information to the tracking portion in conjunction with performing the data set generation process, the tracking portion using the generation notification information in preparing the report.

3. The system of claim 1, further including an encryption portion that performs an encryption process on the data set, the transmission portion receiving the data set from the generation portion through the encryption portion.

4. The system of claim 3, wherein the encryption portion outputs encryption notification information to the tracking portion in conjunction with performing the encryption process, the tracking portion using the encryption notification information in preparing the report.

5. The system of claim 1, wherein the communication portion is an e-mail server.

6. The system of claim 1, wherein the tracking portion includes a log file portion, the log file portion including log files for a plurality of destination entities.

7. The system of claim 6, wherein each log file for a respective customer includes a processing log file record, which is generated based on processing of the data set prior to transmitting the data set, and an acknowledgment log file record, which is generated based on the acknowledgment, wherein the processing log file record includes the transmission notification information.

8. The system of claim 7, wherein the tracking portion further includes a reconciliation portion, the reconciliation portion comparing data in the processing log file record with data in the results log file record to determine receipt of data sets by the destination entity.

9. The system of claim 8, wherein the reconciliation portion outputs comparison data relating to the comparing data in the processing log file record with data in the results log file record, the comparison data being output to a results log file record in the log file.

10. The system of claim 9, further including an encryption portion that performs an encryption process on the data set, the transmission portion receiving the data set from the generation portion through the encryption portion, wherein the encryption portion outputs encryption notification information to the tracking portion in conjunction with performing the encryption process, the tracking portion using the encryption notification information in preparing the report.

11. The system of claim 9, wherein the processing log file contains the transmission notification information and the encryption notification information.

12. The system of claim 1, wherein the data set is a file.

13. The system of claim 1, wherein the transmission portion communicates with the destination entity over the internet, and the destination entity communicates with the communication portion over the internet.

14. A system for performing data transfer with a destination entity, the system comprising:
a generation portion that performs a data set generation process to generate a data set, the data set to be forwarded to the destination entity;
a tracking portion that inputs tracking data regarding operations performed on the data set, the generation portion outputting generation notification information to the tracking portion in conjunction with performing the data set generation process;
a transmission portion, the transmission portion receiving the data set from the generation portion and transmitting the data set to the destination entity, the transmission portion outputting transmission notification information to the tracking portion in conjunction with transmitting the data set to the destination entity;
an encryption portion that performs an encryption process on the data set, the transmission portion receiving the data set from the generation portion through the encryption portion, and the encryption portion outputting encryption notification information to the tracking portion in conjunction with performing the encryption process; and
a communication portion for receiving an acknowledgement from the destination entity, the communication portion outputting any received acknowledgment to the tracking portion;
wherein the tracking portion generates a report including information relating to the generation notification information, the transmission notification information, the encryption notification information and the acknowledgment to provide confirmation of receipt, by the destination entity, of the data set.

15. The system of claim 14, wherein the communication portion is an e-mail server.

16. The system of claim 14, wherein the tracking portion includes a log file portion, the log file portion including log files for a plurality of destination entities, wherein each log file for a respective customer includes a processing log file record, which is generated based on processing of the data set prior to transmitting the data set, and an acknowledgment log file record, which is generated based on acknowledgment information, wherein the processing log file record includes the generation notification information, the transmission notification information, and the encryption notification information.

17. The system of claim 16, wherein the tracking portion further includes a reconciliation portion, the reconciliation portion comparing data in the processing log file record with data in the results log file record to determine receipt of data sets by the destination entity.

18. The system of claim 14, wherein the transmission portion communicates with the destination entity over the internet, and the destination entity communicates with the communication portion over the internet.

19. A method for performing data transfer with a destination entity, the method comprising:
performing a data set generation process in a generation portion to generate a data set, the data set to be forwarded to the destination entity;
outputting the data set from the generation portion to a transmission portion, the transmission portion receiving the data set from the generation portion;
transmitting the data set from the transmission portion to the destination entity, the transmission portion outputting transmission notification information to a tracking portion in conjunction with transmitting the data set to the destination entity;
inputting an acknowledgement, by the tracking portion, from the destination entity; and
generating a report, by the tracking portion, the report including information relating to the transmission notification information and the acknowledgment to provide confirmation of receipt, by the destination entity, of the data set.

20. The method of claim 19, wherein the inputting of the acknowledgement, by the tracking portion, from the destination entity includes the acknowledgment being input through a communication portion, the communication portion being an e-mail server.

21. The method of claim 19, wherein the generation portion outputs generation notification information to the tracking portion in conjunction with performing the data set generation process, the tracking portion using the generation notification information in generating the report.

22. The method of claim 21, further including performing an encryption process on the data set by an encryption portion, the transmission portion receiving the data set from the generation portion through the encryption portion, the encryption portion outputting encryption notification information to the tracking portion in conjunction with performing the encryption process, the tracking portion using the encryption notification information in preparing the report.

23. The method of claim 22, wherein the tracking portion includes a log file portion, the log file portion including log files for a plurality of destination entities, each log file for a respective customer including:
a processing log file record, which is generated based on processing of the data set prior to transmitting the data set and including the transmission notification information, the generation notification information and the encryption notification information; and
an acknowledgment log file record, which is generated based on the acknowledgment.

24. The method of claim 19, wherein the tracking portion includes a log file portion, the log file portion including log files for a plurality of destination entities, each log file for a respective customer including:
a processing log file record, which is generated based on processing of the data set prior to transmitting the data set and including the transmission notification information; and
an acknowledgment log file record, which is generated based on the acknowledgment.

25. The method of claim 24, further including:
comparing data in the processing log file record with data in the acknowledgment log file record to determine receipt of data sets by the destination entity; and
outputting comparison data to a results log file record in a log file for a respective customer.

26. The method of claim 19, wherein the report includes information relating to acknowledgment of files received and non-acknowledgment of files received.

27. A method for performing data transfer with a destination entity, the method comprising:
performing a data set generation process in a generation portion to generate a data set, the data set to be forwarded to the destination entity, the generation portion outputting generation notification information to a tracking portion in conjunction with performing the data set generation process;
outputting the data set from the generation portion to a transmission portion, the transmission portion receiving the data set from the generation portion;
performing an encryption process on the data set by an encryption portion, the transmission portion receiving the data set from the generation portion through the encryption portion, the encryption portion outputting encryption notification information to the tracking portion in conjunction with performing the encryption process;
transmitting the data set from the transmission portion to the destination entity, the transmission portion outputting transmission notification information to the tracking portion in conjunction with transmitting the data set to the destination entity;
inputting an acknowledgement, by the tracking portion, from the destination entity, wherein the inputting includes the acknowledgment being input through a communication portion, the communication portion being an e-mail server; and
generating a report, by the tracking portion, the report including information relating to the generation notification information, the encryption notification information, the transmission notification information and the acknowledgment, to provide confirmation of receipt, by the destination entity, of the data set;
wherein the tracking portion includes a log file portion, the log file portion including log files for a plurality of destination entities, each log file for a respective customer including:
a processing log file record, which is generated based on processing of the data set prior to transmitting the data set and including the transmission notification information, the generation notification information and the encryption notification information; and
an acknowledgment log file record, which is generated based on the acknowledgment, the method further including:
comparing data in the processing log file record with data in the acknowledgment log file record to determine receipt of data sets by the destination entity; and
outputting comparison data to a results log file record in a log file for a respective customer, the comparison data showing acknowledgment of files and non- acknowledgment of files.
